(19) United States
(12) Patent Application Publication
(10) Pub. No.: US 2008/0239716 A1
(43) Pub. Date: Oct. 2, 2008

(54) Light strip

(76) Inventor: Yuan Lin, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/730,358

(22) Filed: Mar. 30, 2007

(51) Int. Cl. F21S 4/00

(52) U.S. Cl. 362/219

(57) ABSTRACT

A light strip generally comprises an inner fixing support, a LED string and an outer fixing body. The inner fixing support is a gel having a slot on the upper portion and several wires embedded in the lower portion. The LED string is formed by coupling several chip-on-board (COB) type LED light-emitting units of 3-primary color (RGB) and a set of conducting wires with a flexible printed circuit board (FPC) for insertion into the slot of the inner fixing support. The set of conducting wires of the LED string is electrically connected to several main wires embedded in the inner fixing support. In addition, the inner fixing support and the LED string are integrally encapsulated with the outer fixing body for providing the light strip with better tensile strength and flexibility.

### FIELD OF THE INVENTION

The present invention relates to a light strip that has better tensile strength and flexibility to be suitable for use in commercial lighting, engineering lighting or route guidance.

### BACKGROUND OF THE INVENTION

In the early-stage multichannel LED light strip, one end of a conducting wire is welded to one pin of a LED lighting device, and then the other end of this conducting wire is welded to another pin of the LED lighting device by bypassing other LED lighting devices so as to form a series-connected light string for facilitating the insertion of the light string into a circular or square hollow sleeve. Then, the above-mentioned structure is integrally encapsulated with a gel by extrusion molding. In this conventional LED light strip, neither fixing nor any support is provided between two adjacent LED lighting devices so the LED lighting devices and the conducting wires will be easily blocked by the inner wall of the hollow sleeve during the insertion of the light string into the hollow sleeve, causing the bending of the conducting wires, which further causes a change in distance between adjacent LED lighting devices. Accordingly, it is very hard to dispose the LED lighting devices equidistantly so the distribution density of light source will be non-uniform. In addition, the conducting wires are pulled and dragged while being bent, causing ill affection on the welding strength.

Nevertheless, a conventional lead frame type or SMD type LED can be applied to the light strip for making the light string. Referring to FIG. 6, a series-connected LED string 2 is inserted into a slot of a pre-shaped inner fixing support 1, and then the inner fixing support 1 is encapsulated into an outer fixing body 3 by extrusion molding so as to form the light strip.

In the above-mentioned LED string, the substrates are connected in series via resistors. In addition, the LED is monochromic light emitting unit, and the positive-pole and negative-pole wires are utilized for electrical connection so it can only generate monochromic light and is unable to change the light color. In addition, the substrates are connected in series via the resistors so the series connection junctions of the resistors will be broken easily by bending, causing inconvenience in maintenance.

Accordingly, according to the motive of the present invention, the present inventor makes diligent studies in providing consumers with an easily flexible and color-changeable light strip.

### SUMMARY OF THE INVENTION

It is a primary object of the present invention to disclose a light strip that couples several COB type LED light-emitting units 21 of 3-primary color (RGB) and a set of conducting wires with a flexible printed circuit board (FPC) to provide a LED string of the light strip with better tensile strength and flexibility, thereby increasing the overall practicability.

It is a secondary object of the present invention to disclose a light strip that integrally couples an inner coupling base and a LED string with an outer fixing body so as to provide the light strip with excellent water resistance and impact resistance, thereby increasing the overall durability.

It is a tertiary object of the present invention to disclose a light strip that mounts a current stabilizer on the flexible printed circuit board of the LED string so as to provide a constant current for thereby saving power and providing uniform brightness and low heat production. In addition, the damage probability of the light-emitting units can be minimized by the use of the current stabilizer. Besides, the devices can be preferably protected and fixed to increase the overall durability.

In order to achieve the foregoing objects, a light strip of the present invention is generally comprised of an inner fixing support, a LED string and an outer fixing body. The inner fixing support is a gel having a slot on the upper portion and several wires embedded in the lower portion. The LED string is formed by coupling several chip-on-board (COB) type LED light-emitting units of 3-primary color (RGB) and a set of conducting wires with a flexible printed circuit board (FPC) for insertion into the slot of the inner fixing support. The set of conducting wires of the LED string is electrically connected to several main wires embedded in the inner fixing support. In addition, the inner fixing support and the LED string are integrally encapsulated in the outer fixing body, thereby providing the light strip with better tensile strength and flexibility.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is a perspective view showing a preferred embodiment of the present invention.

FIG. 2 is a perspective, decomposed view showing the devices in accordance with the preferred embodiment of the present invention.

FIG. 3 is a schematic, assembled view showing the light-emitting units and the flexible printed circuit board in accordance with the preferred embodiment of the present invention.

FIG. 4 is schematic view showing the assembled structure in accordance with the preferred embodiment of the present invention.

FIG. 5 is a diagram showing another preferred embodiment of the present invention.

FIG. 6 is a diagram showing a conventional structure.

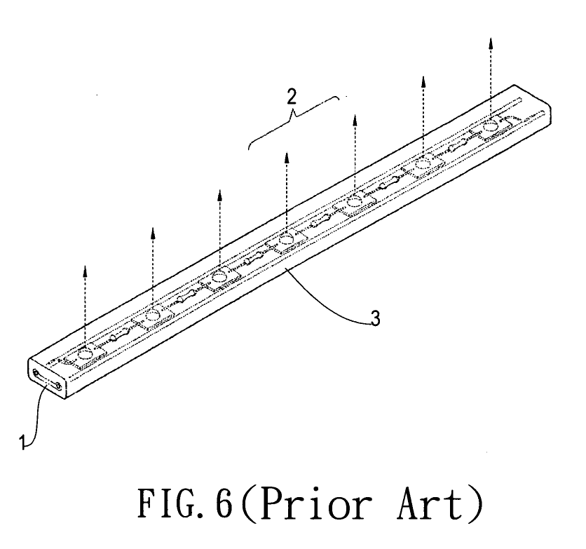

### DETAILED DESCRIPTION OF THE PREFERRED EMBODIMENT

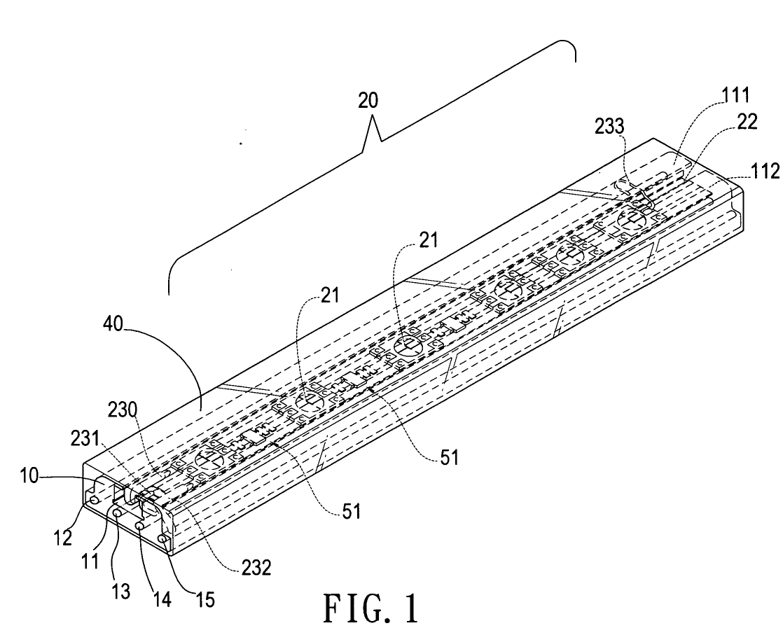

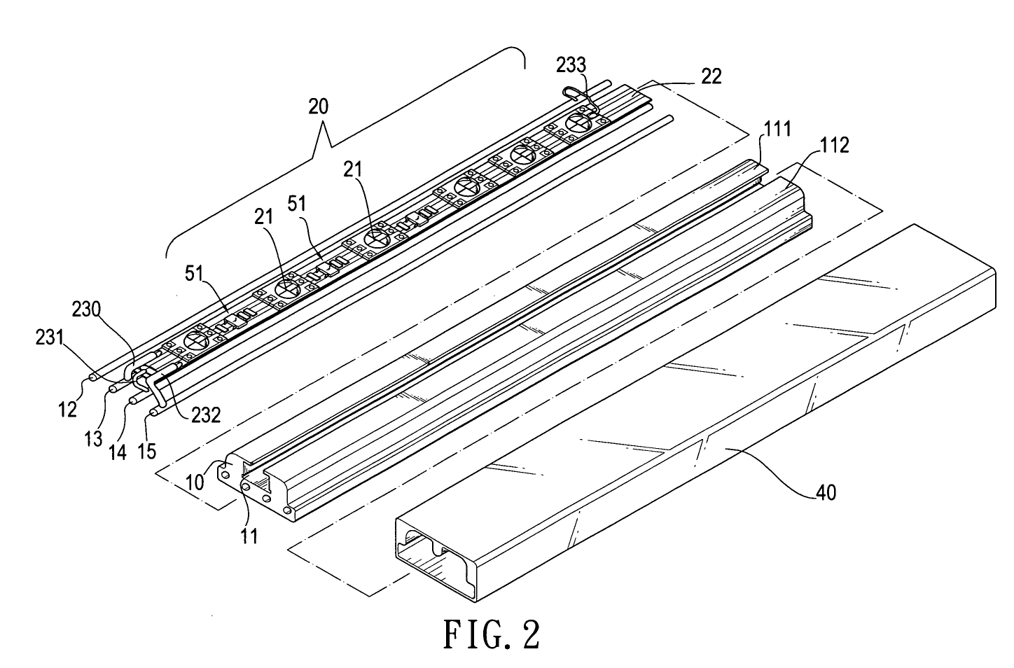

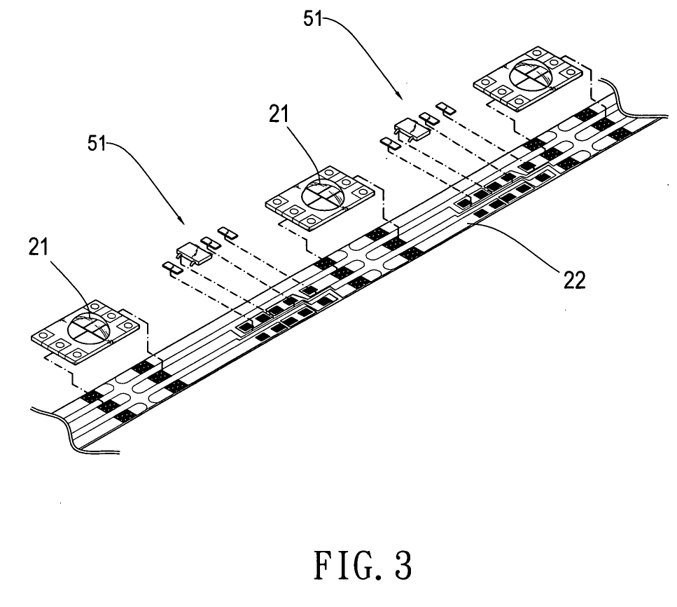

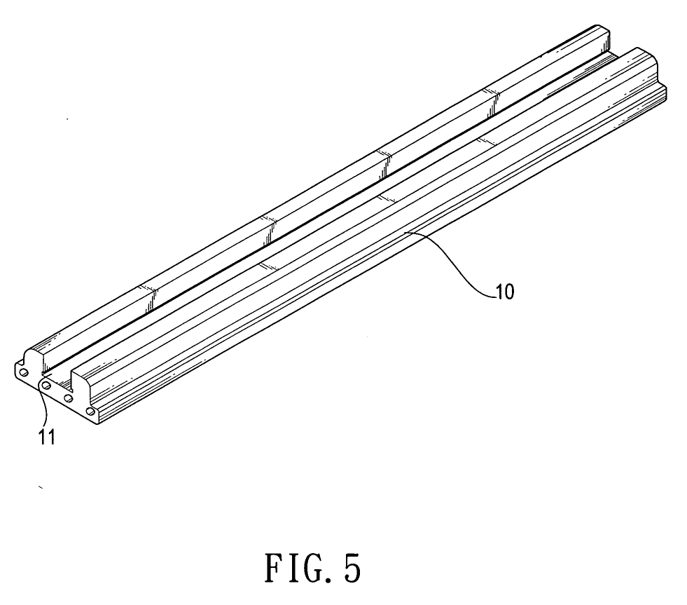

Referring to FIGS. 1 through 5, the present invention relates to a light strip, which comprises an inner fixing support 10, a LED string 20 and an outer fixing body 40. The inner fixing support 10 is a bar-shaped transparent or semi-transparent gel. A U-shaped slot 11 is formed on the upper portion of the inner fixing support 10. Two protrudent plates 111, 112 are projected respectively from both upper sides of the slot 11. Alternatively, the protrudent plates 111, 112 may be not disposed respectively on both upper sides of the slot 11, as shown in FIG. 5. In addition, several wires are embedded in the lower portion of the inner fixing support 10 in parallel. In this preferred embodiment, first through fourth main wires 12 through 15 are utilized for connection with the outside or a connector. The LED string 20 is designed for insertion into the slot 11 of the inner fixing support 10. The LED string 20 is formed by coupling several chip-on-board (COB) type LED light-emitting units 21 of 3-primary color (RGB) and a set of conducting wires with a flexible printed circuit board (FPC) 22. Referring to FIG. 3, the LED light-emitting units 21 are welded to the flexible printed circuit board 22 directly. In addition, the set of conducting wires is composed of first through fourth conducting wires 230 through 233. The electrical connection relationship between these conducting wires and the main wires of the inner fixing support 10 is shown in FIG. 2. The first conducting wire 230 is electrically connected to the second main wire 13 on the left side. The second conducting wire 231 is electrically connected to the third main wire 14 on the right side. The third conducting wire 232 is electrically connected to the fourth main wire 15 on the right side. The fourth conducting wire 233 is electrically connected to the first main wire 12 on the left side. The LED string 20 further has a current stabilizer 51 mounted thereon to provide a constant current, thereby saving power and providing uniform brightness and low heat production. In addition, the damage probability of the light-emitting units can be minimized by the use of the current stabilizer 51. The current stabilizer 51 is composed of a current regulator and an integrated circuit device, and coupled to the flexible printed circuit board 22 of the LED string 20, wherein the integrated circuit device is COB type. The current regulator is SMD type, COB type or PCB type. In addition, the flexible printed circuit board 22 is flexible so the current stabilizer 51 can be provided with better protection. Besides, the outer fixing body 40 and the inner fixing support 10 are of identical gel, and they are both formed by extrusion molding. The outer fixing body 40 is utilized to encapsulate the inner fixing support 10 and the LED string 20 so as to integrate them into a unity for thereby preventing the possible influence caused by the subsequent processing process and for providing the light strip with better tensile strength and flexibility.

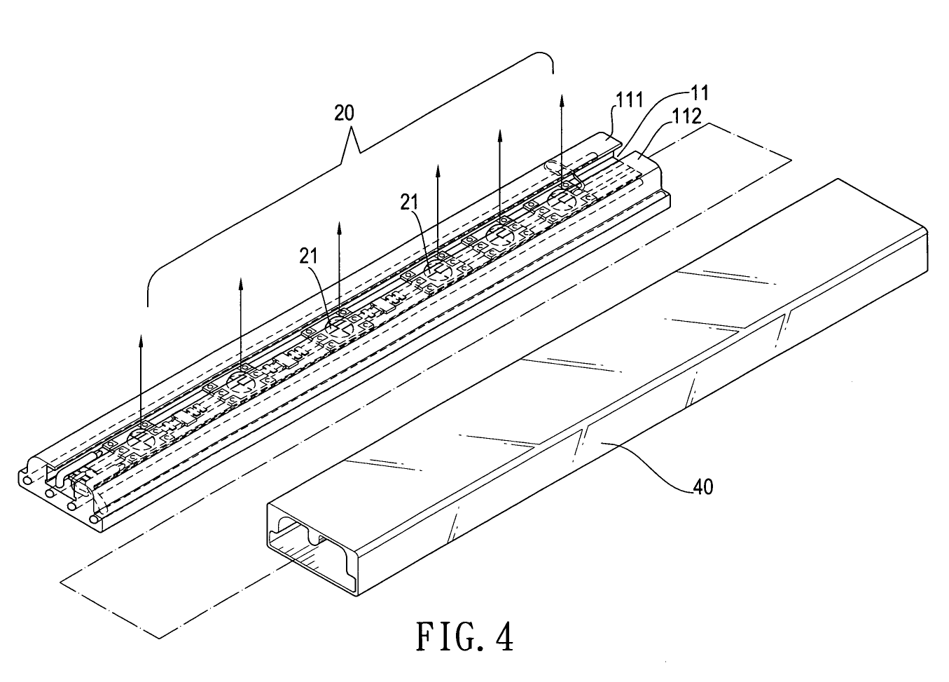

Referring to FIG. 4, for the purpose of assembling the light strip, the LED string 20 is first inserted into the pre-shaped slot 11 of the inner fixing support 10, and fixed by the protrudent plates 111, 112 so as to dispose the COB type LED light-emitting units 21 at a constant interval. The set of conducting wires of the LED string 20 must be electrically connected to these four main wires embedded in the inner fixing support 10, and then processed by extrusion molding so as to integrally encapsulate the inner fixing support 10 and the LED string 20 with the outer fixing body 40 for thereby providing the light strip with better tensile strength and flexibility.

In accordance with the foregoing description, the present invention has the following practical advantages:

1. The COB type LED light-emitting units of 3-primary color are coupled with the flexible printed circuit board to provide changeable color.

2. The current stabilizer can be mounted on the flexible printed circuit board to protect the LED light-emitting units, and the flexible printed circuit board has the better tensile strength and flexibility to increase the lifetime of the product.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

To sum up, the light strip of the present invention is capable of achieving the anticipated performance described above. Therefore, this application is filed according to the patent law.

What the invention claimed is:

1. A light strip, comprising:
an inner fixing support, said inner fixing support being a gel having a slot on the upper portion and a plurality of wires embedded in the lower portion;
a LED string inserted into said slot of said inner fixing support, said LED string being formed by coupling a plurality of chip-on-board (COB) type LED light-emitting units of 3-primary color (RGB) and a set of conducting wires with a flexible printed circuit board (FPC); and
an outer fixing body to integrally encapsulate said inner fixing support and said LED string for thereby providing said light strip with better tensile strength and flexibility.

2. A light strip according to claim 1, wherein said inner fixing support is a transparent gel.

3. A light strip according to claim 1, wherein said inner fixing support is a semi-transparent gel.

4. A light strip according to claim 1, wherein said outer fixing body is a gel made of the same material as that of said inner fixing support.

5. A light strip according to claim 1, wherein each of said chip-on-board (COB) type LED light-emitting units of 3-primary color (RGB) comprises a red light-emitting chip, a green light-emitting chip and a blue light-emitting chip.

6. A light strip according to claim 1, wherein said set of conducting wires is composed of a first conducting wire through a fourth conducting wire, said first conducting wire is electrically connected to a second main wire on the left side, said second conducting wire is electrically connected to a third main wire on the right side, said third conducting wire is electrically connected to a fourth main wire on the right side, and said fourth conducting wire is electrically connected to a first main wire on the left side.

7. A light strip according to claim 1, wherein said LED string further has a current stabilizer mounted thereon, wherein said current stabilizer is composed of a current regulator and an integrated circuit device.

8. A light strip according to claim 1, wherein said slot of said inner fixing support has a U shape.

9. A light strip according to claim 1, wherein said slot of said inner fixing support has a U shape and two protrudent plates are projected respectively from both upper sides of said slot.
